(19) United States
(12) Patent Application Publication
(10) Pub. No.: US 2025/0092544 A1
(43) Pub. Date: Mar. 20, 2025

(54) DOPED METAL PHOSPHORUS TRICHALCOGENIDE AND METHOD FOR PREPARATION THEREOF

(71) Applicant: THE HONG KONG POLYTECHNIC UNIVERSITY, Hong Kong (CN)

(72) Inventors: Jiong ZHAO, Hong Kong (CN); Qiang FU, Hong Kong (CN); Wenqian SHEN, Hong Kong (CN)

(21) Appl. No.: 18/888,228

(22) Filed: Sep. 18, 2024

Related U.S. Application Data
(60) Provisional application No. 63/583,319, filed on Sep. 18, 2023.

(51) Int. Cl. C25B 11/075; C01B 25/14; C25B 1/04; C25B 11/052

(52) U.S. Cl. CPC C25B 11/075; C01B 25/14; C25B 1/04; C25B 11/052; C01P 2002/54; C01P 2002/72; C01P 2002/82; C01P 2002/85; C01P 2004/03; C01P 2004/04; C01P 2006/40

(57) ABSTRACT

Method for preparing a doped metal phosphorus trichalcogenide (dMPT) comprising: (a) contacting a first metal salt, an optional base and a fluorine salt under hydrothermal conditions thereby growing a first metal precursor on a conductive substrate; (b) contacting the first metal precursor with an aqueous solution of a second metal salt thereby forming a doped metal precursor; and (c) contacting the doped metal precursor, phosphorus, and sulfur thereby forming a mixture; and heating the mixture; a dMPT, and a method for producing hydrogen gas using the same.

### CROSS-REFERENCE TO RELATED APPLICATIONS

The present application claims priority from U.S. Provisional Patent Application No. 63/583,319, filed on Sep. 18, 2023, which is hereby incorporated by reference in its entirety.

### STATEMENT REGARDING PRIOR DISCLOSURES BY THE INVENTORS OR JOINT INVENTORS UNDER 37 CFR 1.77 (b) (6)

Part of the present invention was disclosed in a paper published in Nature Communications 14 (1), 6462. This paper is a grace period inventor-originated disclosure disclosed within one year before the filing date of this application and falls within the exceptions defined under 35 USC § 102 (b) (1). This paper is hereby incorporated by reference in its entirety.

### TECHNICAL FIELD

The present disclosure relates to a doped metal phosphorus trichalcogenide (dMPT), methods for preparing the same, an electrode comprising the dMPT, and a method of producing hydrogen gas.

### BACKGROUND

Electrochemical water splitting is a significant hydrogen production technique and involves a complex surface chemical reaction. Catalytic activity is highly dependent on the surface structure of the catalytic materials, particularly in the case of alkaline water electrolysis (AWE) for hydrogen evolution. For alkaline hydrogen evolution reaction (HER) process, surface reconstruction of the catalytic materials is a frequently observed phenomenon and usually leads to the formation of amorphous layer outside the catalysts.

Although many reports have demonstrated that the surface amorphous layer is generated during the alkaline HER process, the fundamental understanding of the surface amorphization process and the role of the resulting amorphous layer on catalysts is still deficient. Additionally, how to effectively leverage the inevitable amorphous layer to further improve the catalytic activity of electrocatalytic material remains a challenging task.

Recently, two-dimensional (2D) metal phosphorus trichalcogenide (MPT) have garnered increasing attention as catalysts for the HER. Compared with other reported transition metal-based electrocatalysts, 2D MPT demonstrate unique crystal structures with a metal layer encapsulated by both chalcogens and phosphorus atoms, as well as abundant [P₂S₆] functional groups. These features provide high specific surface area, tuneable charge states, and appropriate band structures.

However, conventional 2D MPT only have limited activities as a catalyst for the HER. There is thus a need for new materials with improved catalytic activities that address such disadvantage.

### SUMMARY

The doped metal phosphorus trichalcogenide (MPT) described herein can be obtained with a universal modulation strategy, where single-atom catalytic sites are situated within the in situ formed amorphous layer during the alkaline HER process, which enhance the HER activities of 2D MPT. The doped 2D MDT can be used in electrochemical water splitting and effectively produce hydrogen (H₂). The resultant electrocatalyst exhibits superior alkaline HER performance, delivering overpotentials of 58 to 146 mV with a Tafel slope of 64 to 115 mV dec-1. Also, the electrocatalyst displays excellent stability under constant 24 h operation, which is higher than that of most previously reported electrocatalysts.

In a first aspect, provided herein is a method for preparing a doped metal phosphorus trichalcogenide (dMPT), the method comprising:
(a) contacting a first metal salt, an optional base and a fluorine salt under hydrothermal conditions thereby growing a first metal precursor on a conductive substrate;
(b) contacting the first metal precursor with an aqueous solution comprising a second metal salt thereby forming a doped metal precursor; and
(c) contacting the doped metal precursor, phosphorus, and sulfur thereby forming a mixture; and heating the mixture thereby forming the doped metal phosphorus trichalcogenide;
wherein the first metal salt is a salt of nickel, manganese, iron or cobalt; and the second metal salt is salt of ruthenium or platinum.

In certain embodiments, the conductive substrate is selected from carbon cloth, fluorine-doped tin oxide glass, nickel foam and cobalt foam.

In certain embodiments, wherein the first metal salt is selected from the group consisting of nitrate, phosphate, sulfate, chloride, bromide, iodide, and acetate, or hydrates thereof.

In certain embodiments, the phosphorus comprises red phosphorus.

In certain embodiments, the hydrothermal conditions in step (a) comprise at least one of a temperature of 100-150° C. and a reaction time of 5-12 hours.

In certain embodiments, the molar ratio of the first metal salt, the alkalinity source and fluoride salt in step (a) is 1:2-8-6:2-5.

In certain embodiments, in step (b), the first metal precursor is contacted with the aqueous solution comprising a second metal salt for 0.5-20 hours.

In certain embodiments, the second metal has a concentration of 1-10 mg/ml in the aqueous solution.

In certain embodiments, in step (c) the doped metal precursor, phosphorus and sulfur are heated at 280-330° C. for at least 20 minutes followed by 420-480° C. for 4-8 hours.

In certain embodiments, the doped metal precursor, phosphorus and sulfur are heated at a heating rate of 1-10° C./min.

In certain embodiments, in step (c), the molar ratio of the first metal in the doped metal precursor, phosphorus and sulfur is 1:0.5-2:2-4.

In certain embodiments, the second metal is present in an amount from 0.1 to 2 wt % based on the weight of the dMPT.

In a second aspect, provided herein is doped metal phosphorus trichalcogenide (dMPT) obtained by the method of the first aspect.

In certain embodiments, wherein the dMPT comprises a plurality of hexagonal nanosheets.

In certain embodiments, the dMPT further comprise an amorphous layer on at least one surface of the dMPT.

In certain embodiments, the first metal is present in an amount from 0.1 to 2 wt % based on the weight of the dMPT.

In certain embodiments, the second metal is present in an amount from 0.1 to 2 wt % based on the weight of the dMPT.

In a third aspect, provided herein is electrode comprising the dMPT of the second aspect and a base electrode, wherein the base electrode is a planar electrode, including the glassy carbon electrode, a graphite electrode, an indium tin oxide (ITO) electrode, a fluorine doped tin oxide (FTO) electrode, a gas diffusion electrode (GDE), carbon paper electrode, carbon fiber electrode, polycarbonate track etch (PCTE)-based electrode, or titanium-based electrode.

In a fourth aspect, provided herein is an electrochemical cell comprising the electrode of the third aspect, a counter electrode, optionally a reference electrode, and an electrolyte solution comprising water and optionally hydroxide ion.

In a fifth aspect, provided herein is method of producing hydrogen gas, the method comprising providing the of the electrochemical cell of the fourth aspect; and applying an electric current between the electrode and the counter electrode resulting in the electrolytic reduction of water and the formation of hydrogen gas.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts the chematic illustration of synthetic procedures for Ru—NiPS₃ NSs.

FIG. 2 depicts the X-ray diffraction (XRD) pattern of the Ni precursor prepared with hydrothermal method in Example 2.

FIG. 3 depicts the scanning electron microscope (SEM) image of the Ni precursor in Example 2.

FIG. 4 depicts (a) SEM and (b) Transmission electron microscopy (TEM) image of Ru—NiPS₃ NSs (dipping for 16 h).

FIG. 5 depicts AFM image and corresponding height profiles. The results demonstrated that the typical thickness of the nanosheets is around 150 nanometers.

FIG. 6 depicts SEM image of the NiPS₃ sample prepared without dipping in Ru solution.

FIG. 7 depicts (a) high-resolution TEM (HRTEM) image and (b) the corresponding EDS spectrum for NiPS₃ NSs.

FIG. 8 depicts SEM image of the NiPS₃ sample prepared dipping in Ru solution for 0.5 h.

FIG. 9 depicts SEM image of the NiPS₃ sample dipping in Ru solution for 2 h.

FIG. 10 depicts SEM image of the NiPS₃ sample dipping in Ru solution for 4 h.

FIG. 11 depicts SEM image of the NiPS₃ sample dipping in Ru solution for 20 h.

FIG. 12 depicts (a) Aberration-corrected high-angle-annular-dark-field scanning transmission electron microscopy (AC-HAADF) stem image and (b) the corresponding iDPC image of Ru—NiPS₃ along zone axis (Ru atoms are highlighted by yellow circles). (c) the corresponding intensity line profiles taken along the white line in (a), which demonstrated that the Ru atom replaced the Ni atom in the NiPS₃ NSs. (d) showed the Crystal structure of NiPS₃ along the zone axis.

FIG. 13 depicts XRD patterns of various Ru—NiPS₃ NSs with different dipping times in RuCl3 solution.

FIG. 14 depicts Raman spectra of various Ru—NiPS₃ NSs with different dipping times in RuCl3 solution.

FIG. 15 depicts XPS survey spectrum for Ru—NiPS₃ NSs.

FIG. 16 depicts XPS spectra of NiPS₃ NSs. (a) Ni 2p3/2, (b) P 2p, and (c) S 2p.

FIG. 17 depicts Comparison of HER performance for different samples.

FIG. 18 depicts Nyquist plots for samples dipping in RuCl3 solution with different times.

FIG. 19 depicts CV curves for Cdl of the samples (a) without Ru and (b) dipping for 16 h at the scan rates from 20 mV/s to 120 mV/s; and (c) Scan rate dependence of the average capacitive currents for NiPS₃ NSs and Ru—NiPS₃ NSs according to (a) and (b), respectively.

FIG. 20 depicts CV curves for the samples dipping in RuCl3 solution for (a) 0.5 h, (b) 2 h, (c) 4 h, and the corresponding Cdl values.

FIG. 21 depicts LSV curves of (a) NiPS₃ and (b) Ru—NiPS₃ were obtained under different temperatures in 1 M KOH solution. These results were used to calculate the apparent activation energy (Eₐₚₚ) and the pre-exponential factor (Aₐₚₚ) for both catalysts.

FIG. 22 depicts the logarithm of the catalytic current density plotted against 1000 times the reciprocal of the temperature (in Kelvin) to extract the apparent activation energy (Eₐₚₚ) and the pre-exponential factor (Aₐₚₚ) of the HER on (a) NiPS₃ and (b) Ru—NiPS₃ at fixed overpotentials using Arrhenius plots³.

FIG. 23 depicts (a) Eₐₚₚ and (b) The logarithm of pre-exponential factor Aₐₚₚ derived from the intercept during the extraction of Eₐₚₚ for NiPS₃ and Ru—NiPS₃ at fixed overpotentials using the Arrhenius plots, as shown in Supplementary FIG. 20.

FIG. 24 depicts (a) HRTEM image, (b) XRD pattern, and (c) Raman spectrum of Ru—NiPS₃ NSs after immersing in 1 M KOH solution for 24 h.

FIG. 25 depicts the chronopotentiometry data obtained during in situ liquid TEM measurements. The accompanying inset illustrates the structure of the liquid TEM chip.

FIG. 26 depicts in situ TEM sequential images showing the evolution of the Ru—NiPS₃ NSs on GC electrode in about 2 h (scale bar: 0.2 mm).

FIG. 27 depicts in situ sequential SAED pattern showing the evolution of the Ru—NiPS₃ NSs on GC electrode in 125 min (scale bar: 5 1/nm).

FIG. 28 depicts (a) TEM image of the initial Ru—NiPS₃ NSs without electrochemical reaction. (b) and (c) are the TEM image of the select area in (a) (red square) after 10 min and 45 min reaction, respectively (scale bar: 0.1 mm). (d) and (e) are the corresponding SAED patterns for (b) and (c), respectively (scale bar: 5 1/nm).

FIG. 29 depicts Ex situ TEM images of the representative sample Ru—NiPS₃ NSs and the estimated thickness of amorphous layer after stability tests for varying durations (1 h, 4 h, 10 h, and 16 h reaction duration; scale bar: 5 nm). The electrochemical test was operated in 1 KOH solution, with a constant current density of −100 mA cm-2.

FIG. 30 depicts HDDF-STEM images of Ru—NiPS₃ alone and zone axis, which showed that the amorphization process is independent of the crystal plane orientation.

FIG. 31 depicts ICP-OES data of Ru species in electrolyte after different reaction time. Ru—NiPS₃ dipped into the electrolyte for 16 h was chosen as the sample.

FIG. 32 depicts the adsorption energy of different Ru doping sites.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the words “include”, “comprise” or variations such as “includes”, “including” “comprises” or “comprising”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The term “hydrothermal conditions” used herein refers to the conditions sufficient to perform a hydrothermal method. The hydrothermal method is known to use an aqueous solution as a reaction system in a special closed reaction vessel to create a high-temperature, high-pressure reaction environment by heating the reaction system and pressurizing it (or the vapor pressure generated by itself).

The term “chemical vapor transport” (CVT) used herein refers to a process where a condensed phase, typically a solid is volatilized in the presence of a gaseous reactant and deposited elsewhere in the form of crystals.

The present disclosure provides a method for preparing doped metal phosphorus trichalcogenide (dMPT). In this method, trace amounts of heteroatoms are doped into a two-dimensional material by ion exchange, and single-atom catalytic sites are situated within the amorphous layer, that will be formed in situ on the catalyst surface during HER process, which can enhance the HER activities of two-dimensional metal phosphorus trichalcogenide. The role of highly active amorphous edges in the alkaline HER process and regulation of the growth of the surface amorphous layer are examined.

One key for increasing electrocatalytic performance is the surface structure of the catalytic materials. For alkaline HER process, surface reconstruction is a frequently observed phenomenon and usually leads to the formation of amorphous layer outside the catalyst. An edge optimization strategy is introduced in the present disclosure to enhance the catalytic activity of the metal phosphorus trichalcogenide. The inevitable surface reconstruction that occurs during the alkaline HER process is used to stabilize dopants of the second metal in the in situ formed amorphous layer. In the method of the disclosure, the metal atoms are trapped by the in situ formed bridging S₂²⁻ species in the amorphous layer, which may reduce the leaching of the dopant and modify the electronic structure around the active sites. Therefore, it is believed that the modified dMPT enhance the adsorption ability for intermediates and increase the number of active sites that can improve its catalytic performance.

The present disclosure can thereby effectively produce renewable energy of hydrogen and alleviate the problems relating to fossil fuel depletion and environmental pollution.

The obtained catalyst can be applied in energy storage (e.g., Li-ion battery, Na-ion battery, K-ion battery, Zn-air battery and all-solid-state battery) and catalysis (in the processes of HER, oxygen evolution reaction and CO₂ electroreduction reaction), which can be further applied in a number of fields, such as transportation.

The methods described herein can produce catalyst with reduced cost, and the resulted metal-doped catalysts have catalytic efficiencies comparable to commercial catalysts on the market, such as Pt/C catalysts, but at a much cheaper cost.

In a first aspect, the present disclosure provides a method for preparing a doped metal phosphorus trichalcogenide (dMPT), comprising:
(a) contacting a first metal salt, an optional base, and a fluorine salt under hydrothermal conditions thereby growing a first metal precursor on a conductive substrate;
(b) contacting the first metal precursor with an aqueous solution comprising a second metal salt thereby forming a doped metal precursor; and
(c) contacting the doped metal precursor, phosphorus, and sulfur thereby forming a mixture; and heating the mixture thereby forming the doped metal phosphorus trichalcogenide;
wherein the first metal salt is a salt of nickel, manganese, iron or cobalt; and the second metal salt is a salt of ruthenium or platinum.

In certain embodiments, the base may be an organic base, such as urea or hexamethylenetetramine (HMT). In certain embodiments, the base is absent in the hydrothermal method in step (a), and the hydrothermal reaction can be performed in water as the solution.

In certain embodiments, the first metal salt is selected from the group consisting of nitrate, phosphate, sulfate, chloride, bromide, iodide, and acetate, or the hydrates thereof.

In a preferred embodiment, the first metal salt comprises Ni(NO₃)₂, Ni₃ (PO₄)₂, Ni(SO₄)₂, Co(NO₃)₂, CoCl₂, Fe(NO₃)₃, FeCl₃ and NiCl₂, [Ni(acac)₂]₃, or the hydrates thereof, such as Ni(NO₃)₂·6H₂O, NiCl₂·6H₂O and NiSO₄·6H₂O, and mixtures thereof.

In certain embodiments, the second metal salt comprises RuCl₃, Ru(O₂C₅H₇)₃, or hydrates thereof.

In certain embodiments, the first metal precursor is grown on a conductive substrate, which for example can be selected from carbon cloth, fluorine-doped tin oxide glass, nickel foam and cobalt foam.

In certain embodiments, the fluorine salts are those can dissociate in water to produce F⁻. The fluorine salts useful in the method may comprise NaF, KF, NH₄F, AgF or mixtures thereof.

In certain embodiments, the phosphorus comprises red phosphorus.

In certain embodiments, in step (a), the hydrothermal process is performed in a sealed vessel such as an autoclave. The hydrothermal condition can comprise a temperature of 100-150° C., 100-140° C., 100-130° C., 100-120° C. or 100-110° C., for example, 105° C., 110° C., 115° C., 120° C., 125° C., 130° C., 135° C., 140° C., 145° C., 150° C. or any values and/or ranges therebetween. The hydrothermal condition can comprise a reaction time of 5-12 hours, for example, 5 hours, 5.5 hours, 6 hours, 6.5 hours, 7 hours, 7.5 hours, 8 hours, 8.5 hours, 9 hours, 9.5 hours, 10 hours, 10.5 hours, 11 hours, 11.5 hours, 12 hours, or any values and/or ranges therebetween.

In step (a), the molar ratio of the first metal salt, the base and fluoride salt may be in the range of 1:2-8-6:2-5, 1:4-6:2-4, 1:4.5-5.5:2-3, 1:4-5:2-3, or 1:4-5:2-2.5, such as 1:4.5:2.2, 1:4.5:2.3, 1:4.5:2.4, 1:4.5:2.5, 1:5:2.5, 1:5:2.6, 1:5:2.7, 1:5:2.8, 1:5:2.9 or 1:5:3.

In certain embodiments, in step (b), the first metal precursor is contacted with an aqueous solution for ion exchanging for 0.5-20 hours, for example, 0.5 hours, 1 hours, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, 8 hours, 8.5 hours, 9 hours, 9.5 hours, 10 hours, 10.5 hours, 11 hours, 11.5 hours, 12 hours, 12.5 hours, 13 hours, 13.5 hours, 14 hours, 14.5 hours, 15 hours, 15.5 hours, 16 hours, 16.5 hours, 17 hours, 17.5 hours, 18 hours, 18.5 hours, 19 hours, 19.5 hours, 20 hours or any values and/or ranges therebetween. In certain embodiments, in step (b), the first metal precursor is immersed in an aqueous solution of the second metal salt for ion exchanging.

In certain embodiments, the second metal salt in step (b) has a concentration of 1-10 mg/ml in the aqueous solution, such as 1 mg/ml, 1.5 mg/ml, 2 mg/ml, 2.5 mg/ml, 3 mg/ml, 3.5 mg/ml, 4 mg/ml, 4.5 mg/ml, 5 mg/ml, 5.5 mg/ml, 6 mg/ml, 6.5 mg/ml, 7 mg/ml, 7.5 mg/ml, 8 mg/ml, 8.5 mg/ml, 9 mg/ml, 9.5 mg/ml, 10 mg/ml or any values and/or ranges therebetween.

In certain embodiments, the reaction in step (c) is carried out by heating the doped metal precursor, phosphorus and sulfur in two stages for chemical vapor transport: in a first heating stage, the above reactants are heated to the temperature of 280-330° C., such as 280° C., 285° C., 290° C., 295° C., 300° C., 305° C., 310° C., 315° C., 320° C., 325° C., 330° C. or any values and/or ranges therebetween, for at least 20 minutes, such as 20 minutes, 25 minutes, 30 minutes, 35 minutes, 40 minutes 45 minutes or any values and/or ranges therebetween; and in a second heating stage, the above reactants are further heated to the temperature of 420-480° C., such as 420° C., 425° C., 430° C., 435° C., 440° C., 445° C., 450° C., 455° C., 460° C., 465° C., 470° C., 475° C., 480° C. or any values and/or ranges therebetween, for at least 0.5 hours, 1 hours, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, 8 hours or any values and/or ranges therebetween.

In certain embodiments, the heating rate in the first and second heating stages may independently range from 1 to 10° C./min, 3-8° C./min, 4-8° C./min, 4-6° C./min, for example, 1° C./min, 1.5° C./min, 2° C./min, 2.5° C./min, 2.5° C./min, 3° C./min, 3.5° C./min, 4° C./min, 4.5° C./min, 5° C./min, 5.5° C./min, 6° C./min, 6.5° C./min, 7° C./min, 7.5° C./min, 8° C./min, 8.5° C./min, 9° C./min, 9.5° C./min, 10° C./min or any values and/or ranges therebetween.

In step (c), the molar ratio of the first metal in the doped metal precursor, phosphorus and sulfur is 1:0.5-2:2-4, a preferred ratio range can be 1:0.5-1:2-3.5 or 1:0.5-1:2-3, such as 1:0.8:2.8, 1:0.8:2.9, 1:0.8:3.0, 1:0.9:2.8, 1:0.9:2.9, 1:0.9:3, 1:1:3, 1:1:3.1, 1:1:3.2 or 1:1:3.3, or any values and/or ranges therebetween.

In certain embodiments, the method for preparing doped metal phosphorus trichalcogenide (dMPT), comprises:
(a) contacting Ni(NO₃)₂·6H₂O, urea, and NH₄F under hydrothermal conditions thereby growing Ni precursor on a conductive substrate;
(b) contacting the Ni precursor with an aqueous solution of RuCl3 thereby forming a Ru—Ni precursor; and
(c) contacting the Ru—Ni precursor, phosphorus, and sulfur thereby forming a mixture; and heating the mixture thereby forming the Ru—NiPS₃.

In a second aspect, the present disclosure provides a doped metal phosphorus trichalcogenide (dMPT) obtained by the method described above.

In certain embodiments, the dMPT is in the form of a hexagonal nanosheet with random arrangement.

A low thickness of the dMPT nanosheet can expose more active sites, which can improve catalytic activity. In certain embodiments, the dMPT nanosheets have an average thickness of 50-300 nm, 50-280 nm, 50-250 nm, 80-200 nm or 100-150 nm. For example, the thickness of dMPT nanosheets is 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm or any values and/or ranges therebetween.

In certain embodiments, the dMPT comprises the first metal in an amount from 1 to 10 wt % based on the weight of the dMPT. In certain embodiments, the amount of first metal is 4-8 wt %, 4.5-7 wt %, or 5.5-6.5 wt %.

In certain embodiments, the dMPT comprises the second metal in an amount from 0.1 to 2 wt % based on the weight of the dMPT. In certain embodiments, the second metal is 0.1-1.5 wt %, 0.5-1.5 wt % or 0.5-0.8 wt %.

Also provided is an electrode comprising the dMPT and a base electrode. In certain embodiments, the dMPT is coated on the surface of the base electrode. The base electrode can be an any electrode, such as a glassy carbon electrode, a graphite electrode, an indium tin oxide (ITO) electrode, a fluorine doped tin oxide (FTO) electrode, a gas diffusion electrode (GDE), carbon paper electrode, carbon fiber electrode, polycarbonate track etch (PCTE)-based electrode, or titanium-based electrode. In certain embodiments, the electrode is a cathode.

Also provided is an electrochemical cell comprising two or more electrodes, wherein the two or more electrodes can comprise an electrode comprising the dMPT described herein, a counter electrode (or counter/reference electrode), optionally a reference electrode (e.g., in a three-electrode system) and a neutral or basic electrolyte solution between and in contact with the electrode, the counter electrode, and optionally the reference electrode.

A counter electrode refers to an electrode paired with the working electrode, through which passes a current equal in magnitude and opposite in sign to the current passing through the working electrode. The counter electrode can include counter electrodes which also function as reference electrodes (i.e., a counter/reference electrode). Any suitable counter electrode known in the art can be used in connection with the methods described herein. For example, the counter electrode can comprise carbon (e.g., highly oriented pyrolytic graphite), a metal (e.g., platinum), an alloy (e.g., stainless steel), glassy carbon, a conductive polymer, or the like.

The reference electrode can be selected from a standard hydrogen electrode, calomel electrode, copper-copper (II) sulfate electrode, silver chloride electrode, palladium-hydrogen electrode, mercury-mercurous sulfate electrode, and the like.

In certain embodiments, electrolyte solution can be neutral. In certain embodiments, electrolyte solution can be basic. The electrolyte solution can comprise hydroxide derived from a hydroxide source selected from the group consisting of LiOH, NaOH, KOH, CsOH, Mg(OH)₂, Ca(OH)₂, Sr(OH)₂, and a mixture thereof.

The concentration of hydroxide ion in the electrolyte solution can range from 0.1-10 M, 0.1-9 M, 0.1-8 M, 0.1-7 M, 0.1-6 M, 0.1-5 M, 0.1-4 M, 0.1-3 M, 0.1-2 M, 0.5-1.5 M, or 0.75-1.25 M. In certain embodiments, the concentration of hydroxide ion in the electrolyte solution is about 1 M.

The present disclosure also provides a method of producing hydrogen gas, the method comprising applying an electric current between the electrode comprising the dMPT described herein and the counter electrode resulting in the electrolytic reduction of water and the formation of hydrogen gas.

The dMPT can have an overpotential between 20-85 mV, 20-67 mV, 20-53 mV, 20-50 mV, 20-45 mV, 20-40 mV, 20-35 mV, 20-30 mV, or 20-25 mV, when used as an electrocatalyst in a hydrogen evolution reaction at a current density of 10 mA cm-2 at 25° C. in an electrolyte comprising 1 M KOH. In certain embodiments, the dMPT has an overpotential of about 20 mV when used as an electrocatalyst in a hydrogen evolution reaction at a current density of 10 mA cm 2 at 25° C. in an electrolyte comprising 1 M KOH.

As mentioned, the dMPT produced herein can be used in the catalytic reaction in Li-ion battery, Na-ion battery, K-ion battery, Zn-air battery and all-solid-state battery.

### EXAMPLES

### Preparation and Characteristics of the Doped Metal Phosphorus Trichalcogenide (dMPT)

### Comparative Example 1

A mixture of nickel (10 mg), red phosphorus (10 mg) and sulfur powder (30 mg) were sealed in a quartz tube. The quartz tube was heated at 300° C. for 30 min and then heated at 450° C. for 5 h, with a heating rate of 5° C./min. The obtained NiPS₃ single crystal was dried in vacuum at 60° C.

### Comparative Example 2

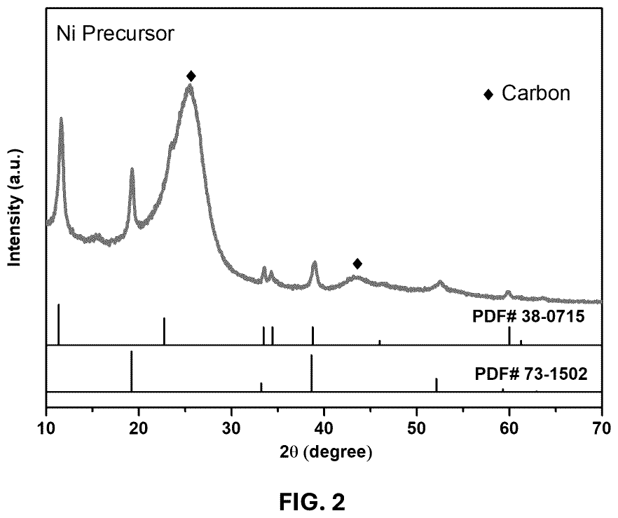

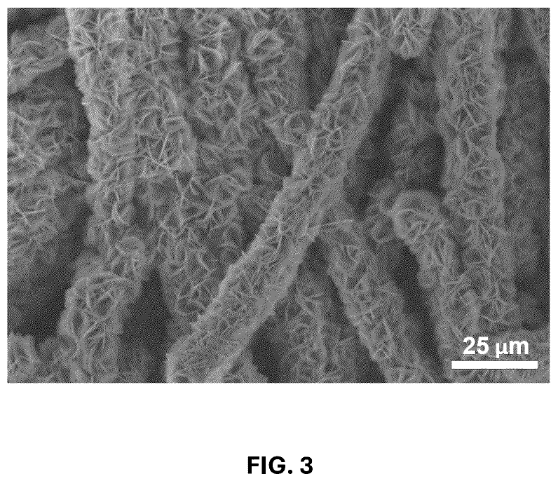

Ni(NO₃)₂·6H₂O (2 mmol), urea (10 mmol), and NH₄F (5 mmol) were added into DI water (40 mL). The resulted mixture and a piece of carbon cloth (CC) were added into a 50 mL Teflon-lined stainless-steel autoclave and heated at 130° C. for 8 h to obtain a Ni precursor. FIG. 2 shows the XRD pattern of the Ni precursor prepared in this Comparative Example. FIG. 3 shows the SEM image of the Ni precursor.

The Ni precursor (10 mg) was dried in a vacuum at 60° C. for 8 hours, and then was sealed along with red phosphorus (10 mg) and sulfur powder (30 mg) in a quartz tube, which was heated at 300° C. for 30 min and then at 450° C. for 5 h, with a heating rate of 5° C./min to prepare NiPS₃ nanosheets (NSs). The NiPS₃ NSs then was dried in vacuum at 60° C.

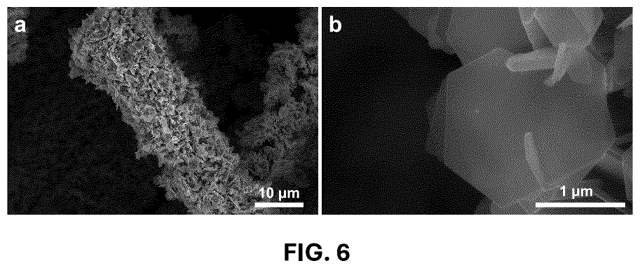

FIG. 6 shows SEM image of the NiPS₃ sample prepared without immersing in Ru solution in this Comparative Example.

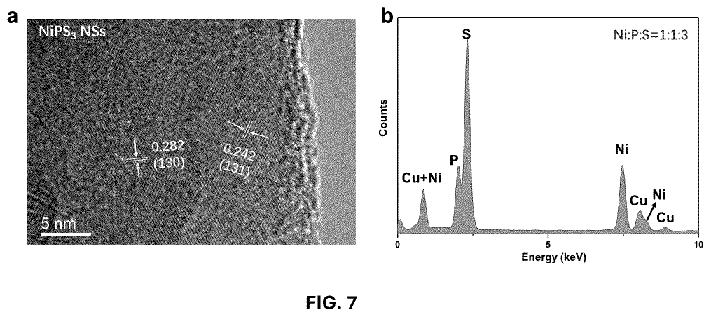

FIG. 7 shows (a) high resolution transmission electron microscopy (HRTEM) image and (b) the corresponding EDS spectrum for the prepared NiPS₃ NSs, which demonstrates interplanar crystal spacing and the elementary composition of the prepared sample. The EDS spectrum clearly demonstrates the ratio of Ni:P:S is around 1:1:3, further confirmed the formation of NiPS₃ crystal.

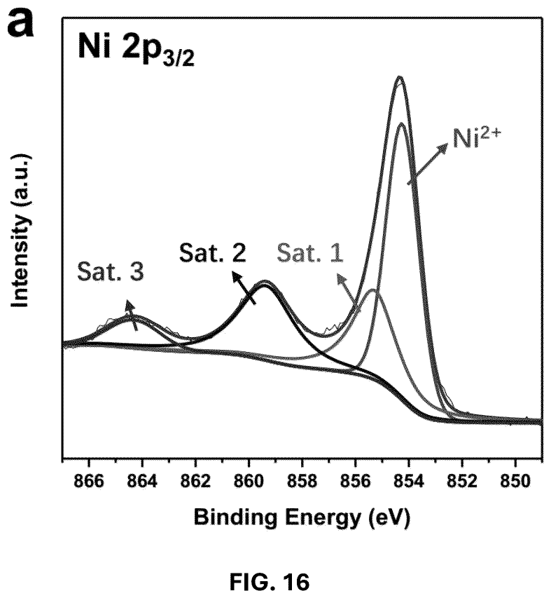

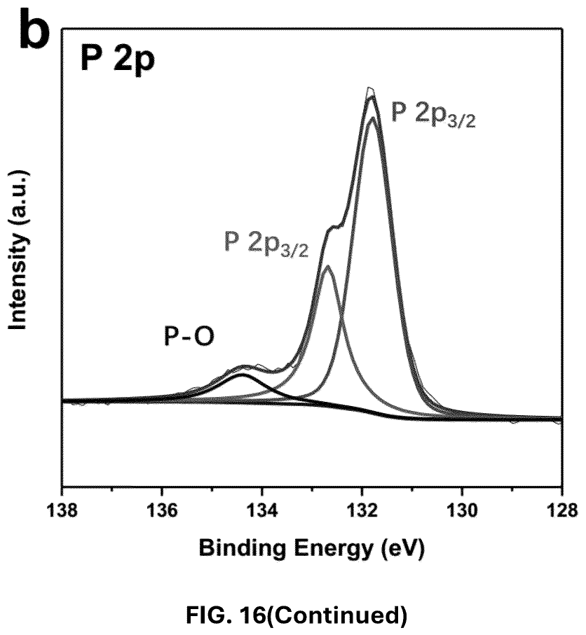

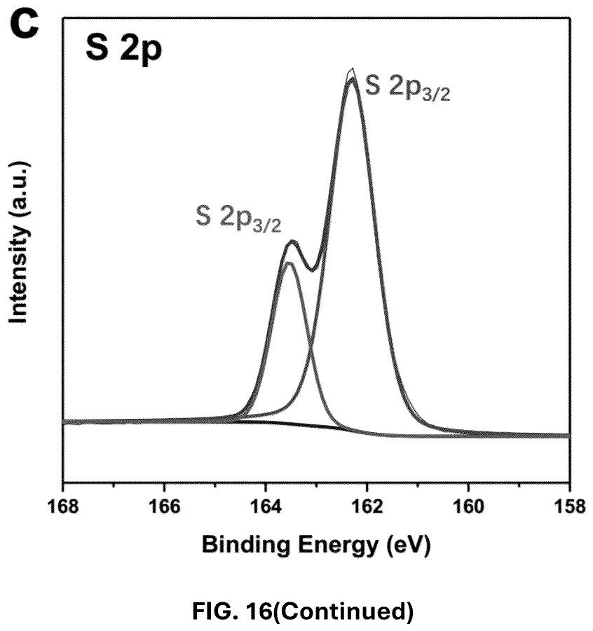

FIGS. 16a-16c show the XPS spectra of NiPS₃ NSs. (a) Ni 2p3/2, (b) P 2p, and (c) S 2p, which demonstrate the valence of Ni is mainly +2, and there is no obvious oxidation after the preparation process.

### Preparation Example 1

Ni(NO₃)_{2·}6H₂O (2 mmol), urea (10 mmol), and NH₄F (5 mmol) were added into DI water (40 mL). The resulted mixture and a piece of carbon cloth (CC) were added into a 50 mL Teflon-lined stainless-steel autoclave and heated at 130° C. for 8 h to obtain a Ni precursor (the first metal precursor). The Ni precursor was dried in a vacuum at 60° C. for 8 hours. The Ni precursor was immersed into the RuCl3 aqueous solution (3 mg/ml) for 0.5 h to obtain a Ru—Ni precursor (the doped metal precursor). The Ru—Ni precursor (10 mg) then was sealed along with red phosphorus (10 mg) and sulfur powder (30 mg) in a quartz tube, which was heated at 300° C. for 30 min and then at 450° C. for 5 h, with a heating rate of 5° C./min to prepare Ru—NiPS₃ nanosheets (NSs). The Ru—NiPS₃ NSs then was dried in vacuum at 60° C.

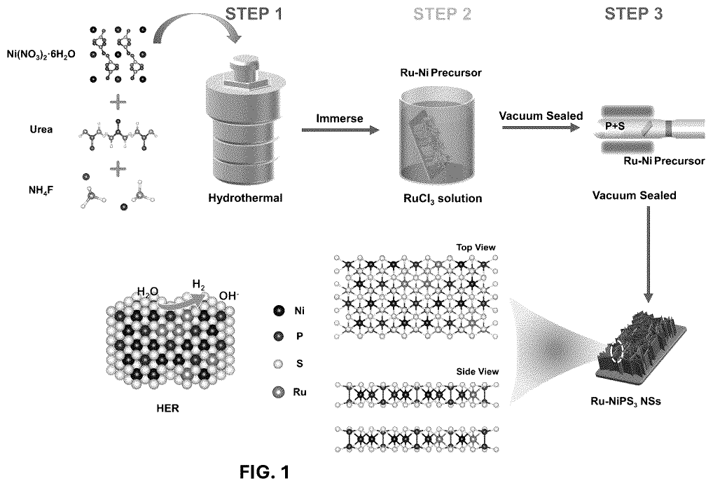

FIG. 1 shows the synthetic procedures for Ru—NiPS₃ NSs prepared in Preparation Example 1. As can be seen, in the Ru—NiPS₃ NSs, Ru atoms are at the edge sites of each NSs and trapped by the bridging S₂²⁻ species, which may reduce the leaching of the dopant Ru and modify the electronic structure around the active sites.

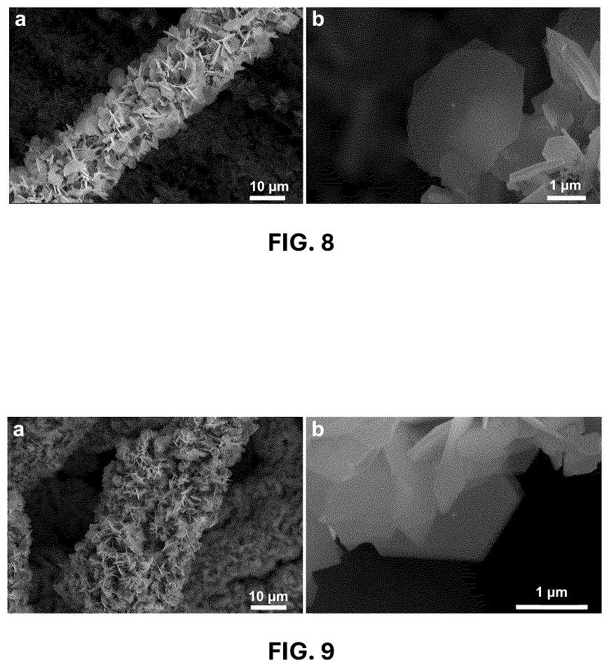

FIG. 8 shows the SEM image of the NiPS₃ sample prepared by immersing in Ru solution for 0.5 h, which indicates that the immersing process did not influence the morphology of the nanosheet.

### Preparation Examples 2-6

These examples were performed in the same procedures as that in Preparation Example 1 except with the following immersion time.

| | Preparation | Preparation | Preparation | Preparation | Preparation | Preparation |
|---|---|---|---|---|---|---|
| | Example 2 | Example 3 | Example 4 | Example 5 | Example 6 | Example 7 |
| Immersion | 1 | 2 | 4 | 10 | 16 | 20 |
| time/hour(s) | | | | | | |

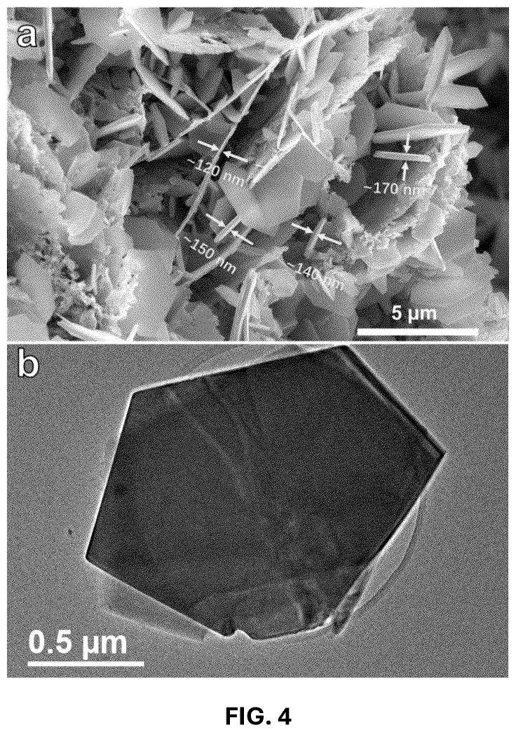

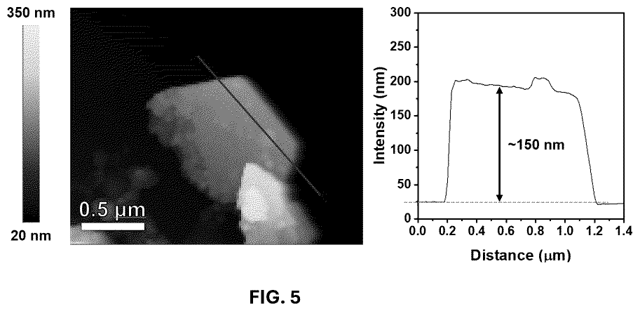

FIG. 4 shows (a) SEM and (b) TEM image of Ru—NiPS₃ NSs in Preparation Example 6. As can be seen, the prepared Ru—NiPS₃ NSs have a hexagonal shape with haphazard arrangement and have a thickness of 120-170 nm. The AFM image further show the typical thickness of the nanosheets is around 150 nm (FIG. 5).

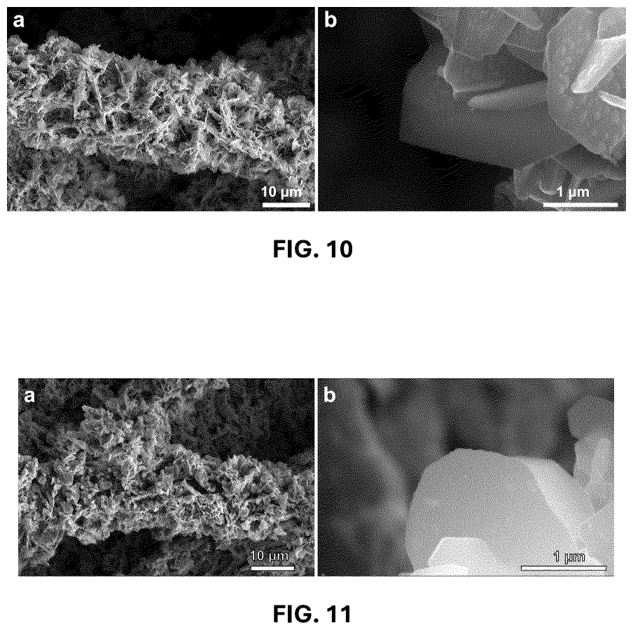

FIGS. 9-11 show the SEM image of the NiPS₃ sample prepared by immersing in Ru solution for 2 hours, 4 hours or 20 hours in Preparation Examples 3-4 and 7, which indicate that the immersing process did not influence the morphology of the nanosheet.

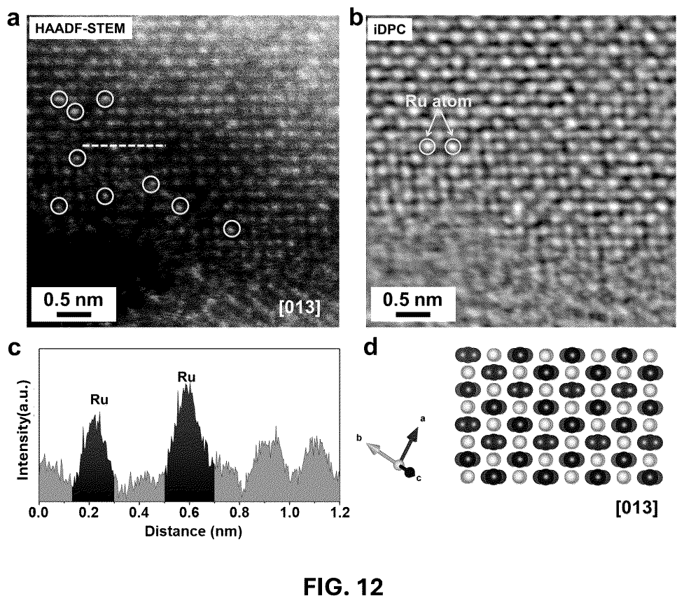

FIG. 12 shows results of the Ru—NiPS₃ in Preparation Example 6: (a) AC-HAADF stem image; (b) the corresponding iDPC image of Ru—NiPS₃ along zone axis (Ru atoms are highlighted by circles); (c) the corresponding intensity line profiles taken along the dashed line in image (a), which demonstrated that the Ru atom replaced the Ni atom in the NiPS₃ NSs; and (d) showed the crystal structure of Ru—NiPS₃ along the zone axis, which demonstrated that Ru replaces the Co sites in NiPS₃ rather than adsorbed on the surface.

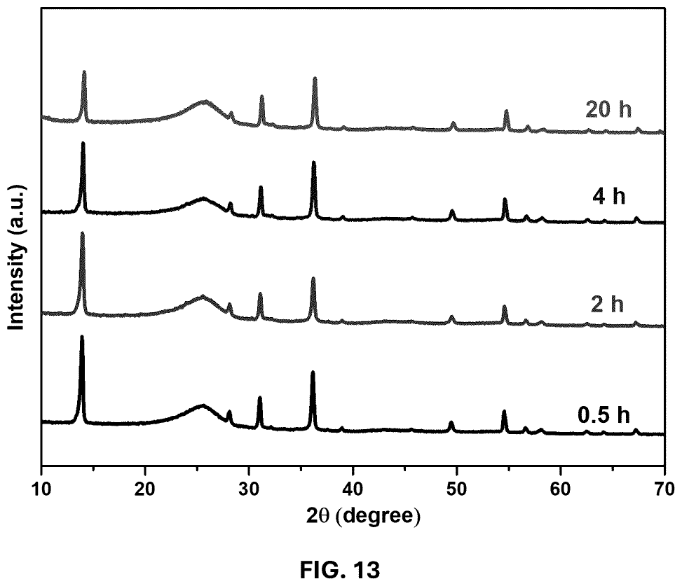

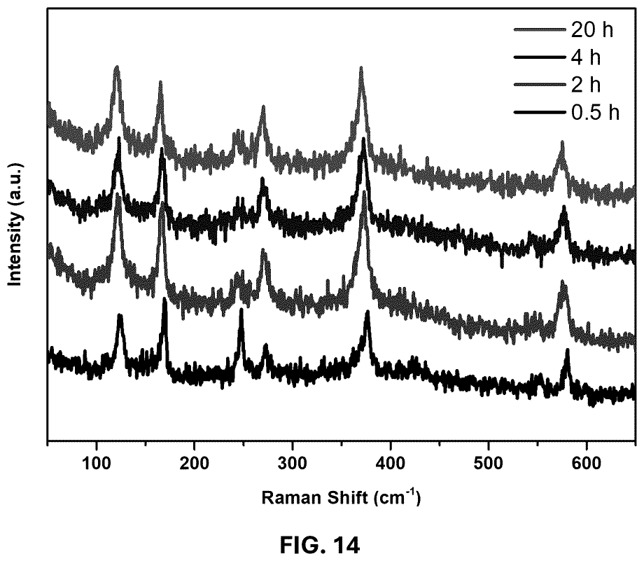

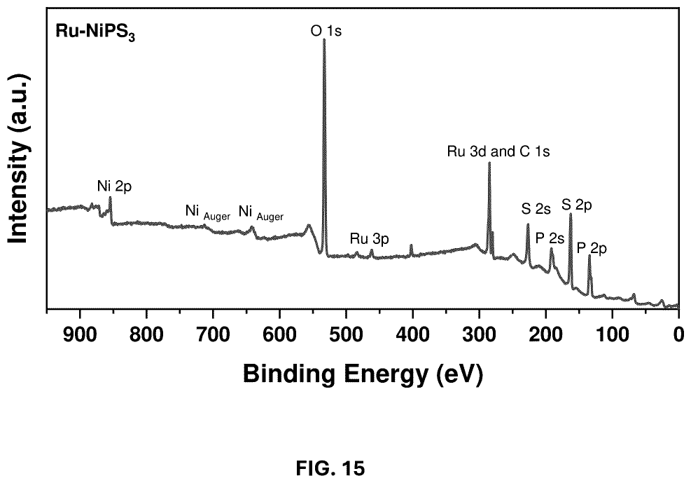

The different immersing time in the aqueous solution of a salt of the second metal resulted in different microstructural and content of the metals in the Ru—NiPS₃ NSs. FIGS. 13-14 shows XRD patterns and Raman spectra of various Ru—NiPS₃ NSs with different immersing time in RuCl3 solution, wherein the Ni content decreased while the Ru content increased with time. FIG. 15 shows the XPS survey spectrum for Ru—NiPS₃ NSs obtained from Preparation Example 6.

The samples of NiPS₃ and Ru—NiPS₃ in Comparative Example 2 and Preparation Example 6 were measured for element composition with ICP-OES (Inductively coupled plasma-optical emission spectrometry), and the results are shown in Tables 1-2.

TABLE 1
ICP-OES results of NiPS₃

| Sample | Element | Content (wt. %) |
|---|---|---|
| NiPS₃ | Ni | 6.80 |
| | P | 4.62 |
| | S | 10.60 |

TABLE 2
ICP-OES results of Ru—NiPS₃ electrodes treated
with RuCl₃ solution for varying durations

| | | |
|---|---|---|
| | | Content |
| Immersing time | Element | (wt. %) |

| | | | |
|---|---|---|---|
| 0.5 | h | Ni | 4.59 |
| | | P | 5.00 |
| | | S | 11.61 |
| | | Ru | 0.16 |
| 2 | h | Ni | 4.31 |
| | | P | 5.22 |
| | | S | 12.68 |
| | | Ru | 0.22 |
| 4 | h | Ni | 3.29 |
| | | P | 4.70 |
| | | S | 14.01 |
| | | Ru | 0.36 |
| 16 | h | Ni | 6.24 |
| | | P | 4.99 |
| | | S | 11.74 |
| | | Ru | 0.81 |
| 20 | h | Ni | 5.77 |
| | | P | 3.77 |
| | | S | 11.70 |
| | | Ru | 0.79 |

As can be seen, Ni content decreased due to the doping of Ru, and the immersing time of 16 h resulted in the maximum Ru concentration.

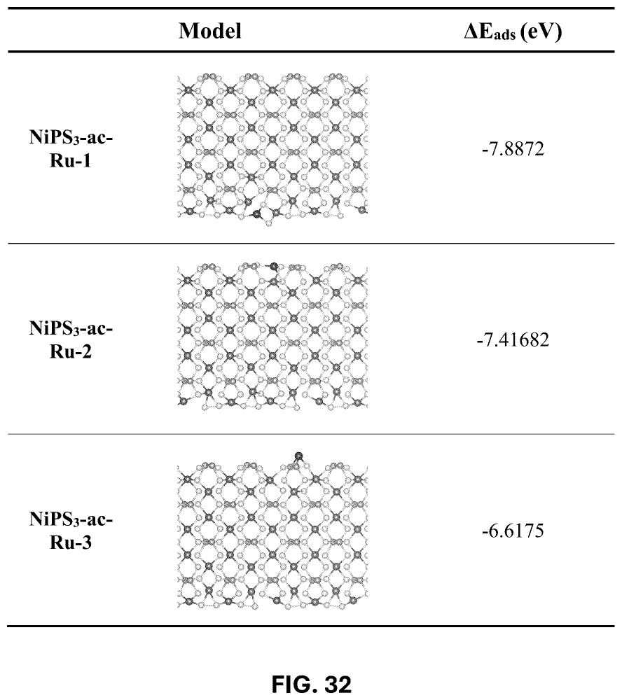

FIG. 32 shows adsorption energy of different Ru doping sites, wherein a negative value of ΔE_{ads} corresponds to an exothermic process, and a more negative value indicates a more stable Ru atom in NiPS₃ substrate, which is the indicator for a more stable calculation model. For NiPS₃-ac-Ru—1, the Ru atom was doped into the S₂²⁻ group, which connects with S atoms. As a comparison, the Ru atom in NiPS₃-ac-Ru—2 was doped into the lattice where there is no S₂²⁻ group around it. For NiPS₃-ac-Ru—3 Ru atom was adsorbed at the edge of NiPS₃.

Performance Evaluation of the dMPT

### 1. Catalytic Performance in HER

To evaluate the performance of different Ru—NiPS₃ NSs samples in HER, the inventors measured the hydrogen production rate with the linear sweep voltammetry (LSV) technique by electrochemical workstation (CHI-760E) in alkaline media (1 M KOH, at room temperature).

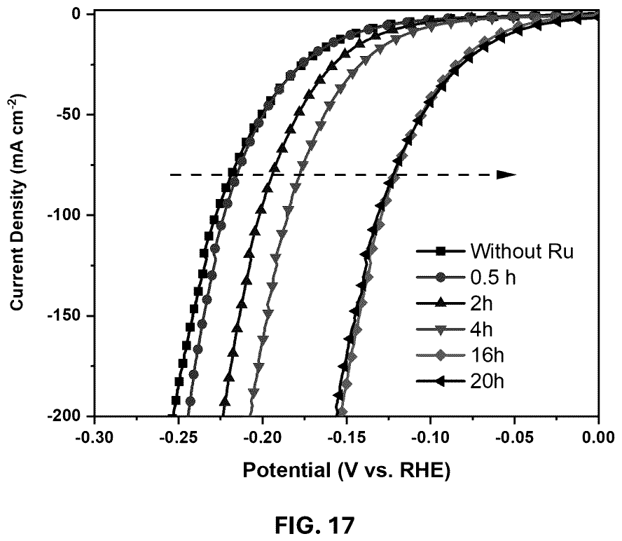

The HER performances for different samples are compared in FIG. 17. As shown in the Figure, the potential relative to reversible hydrogen electrode (RHE) obtained with the NiPS₃ NSs sample without Ru is around-0.25 V. The potential increases with the immersing time and is close to −0.15 V at the immersing time of 16 hours.

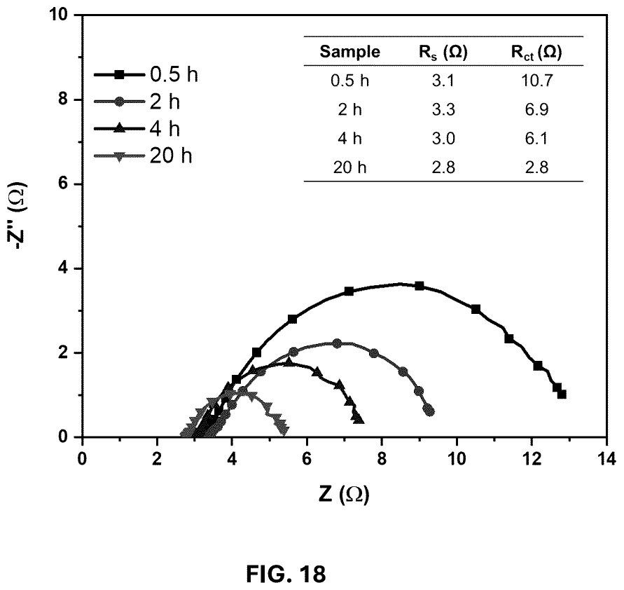

FIG. 18 further shows the Nyquist plots for samples with different immersing time in RuCl3 solution. This figure also shows dipping in Ru solution for 20 h could results in the lowest charge transfer resistance, which facility the HER process.

We further measured electrochemical double-layer capacitances (C_{d1}) with a simple cyclic voltammetry (CV) method to evaluate the electrochemical surface area of the fabricated catalysts.

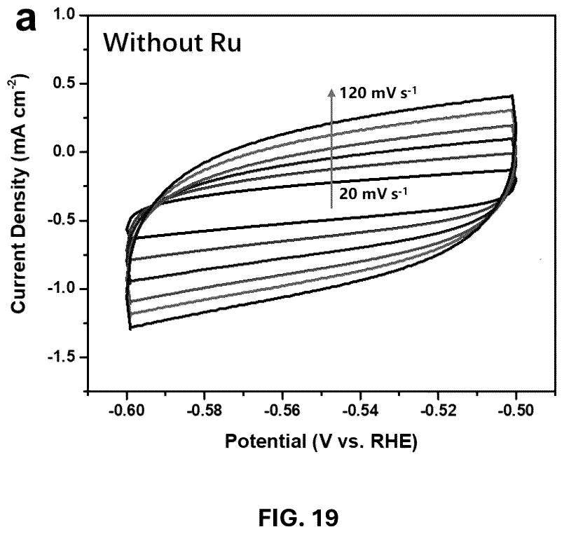

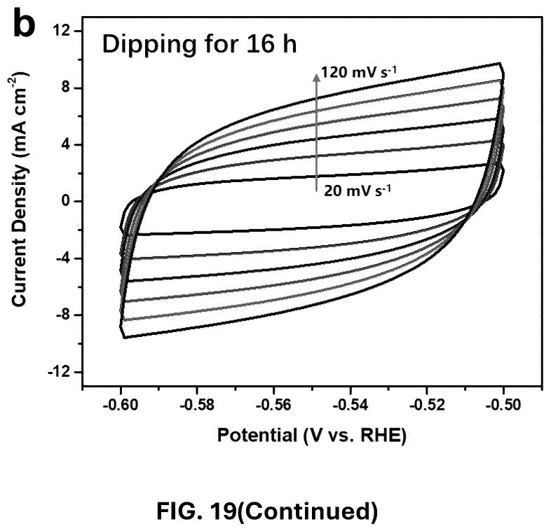

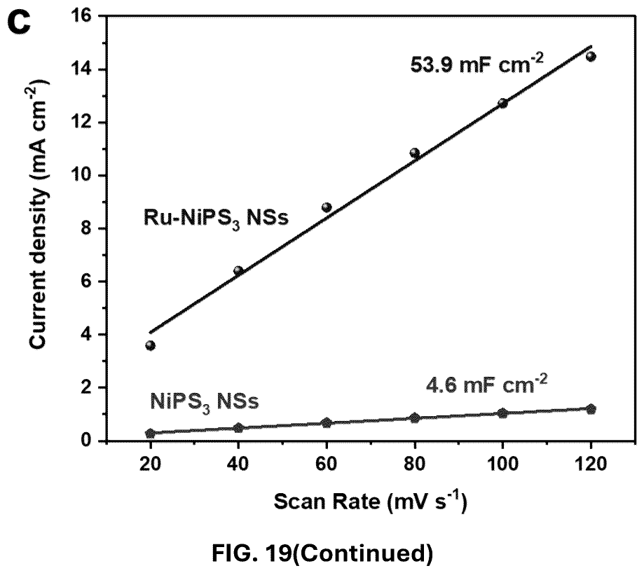

FIGS. 19a-19c demonstrates the CV curves for Cal of the samples (a) without dipping and (b) dipping for 16 h in Ru solution at the scan rates from 20 mV s⁻¹ to 120 mV s⁻¹; and (c) Scan rate dependence of the average capacitive currents for NiPS₃ NSs and Ru—NiPS₃ NSs according to (a) and (b), respectively.

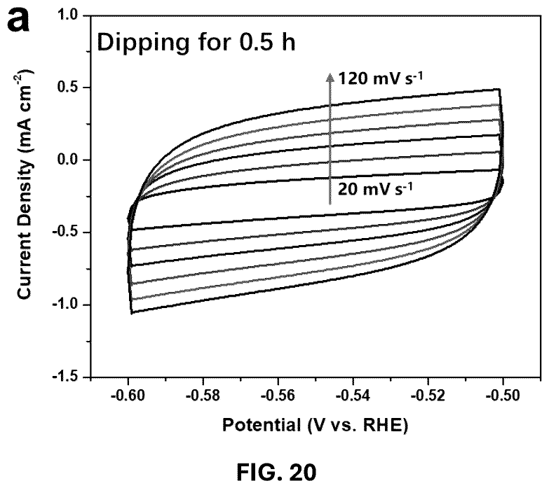

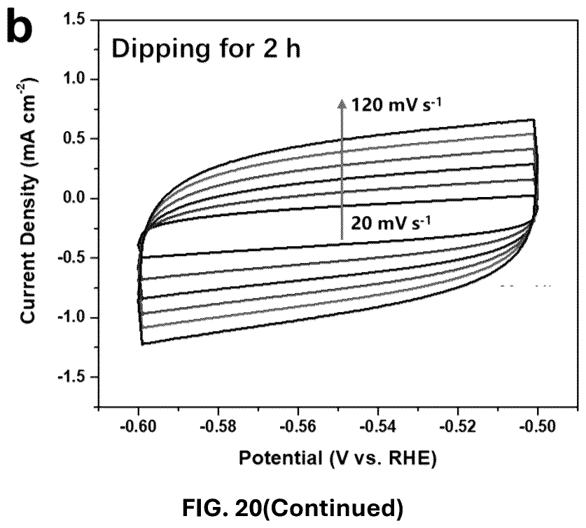

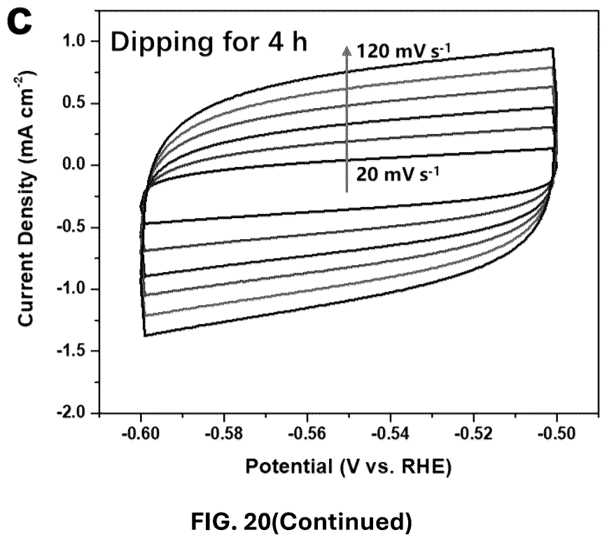

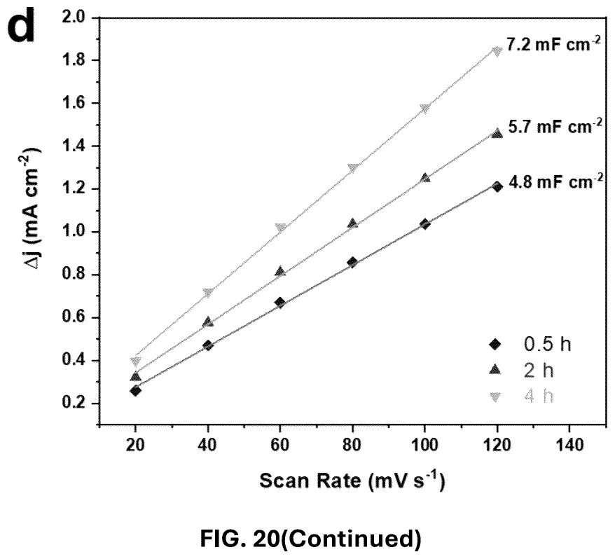

FIGS. 20a-20d show CV curves for the samples obtained in the preparation examples. CV curves for the samples dipping in RuCl₃ solution for (a) 0.5 h, (b) 2 h, (c) 4 h, and (d) the corresponding Cal values, which are directly proportional to the effective surface area of the catalyst. Obviously, as can be seen from FIG. 20, the Ca values are obtained to be ˜4.8, 5.7 and 7.2 mF/cm² for the samples in Preparation Examples 1-3, indicating that the catalyst sample in Preparation Example 3 has a greater active surface area.

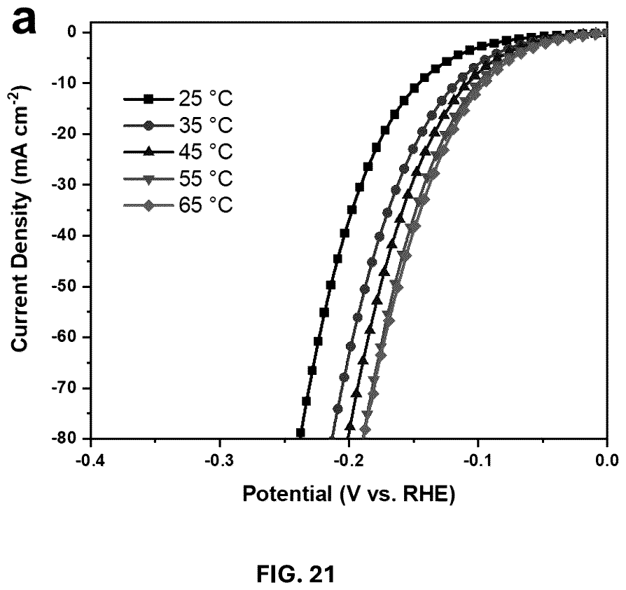

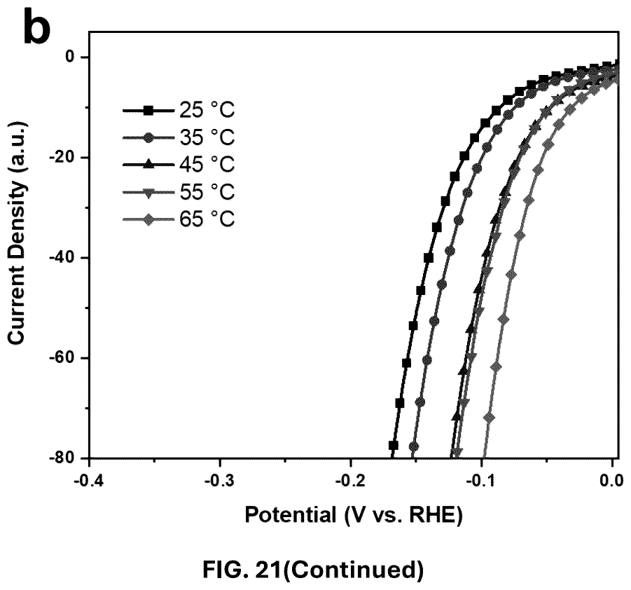

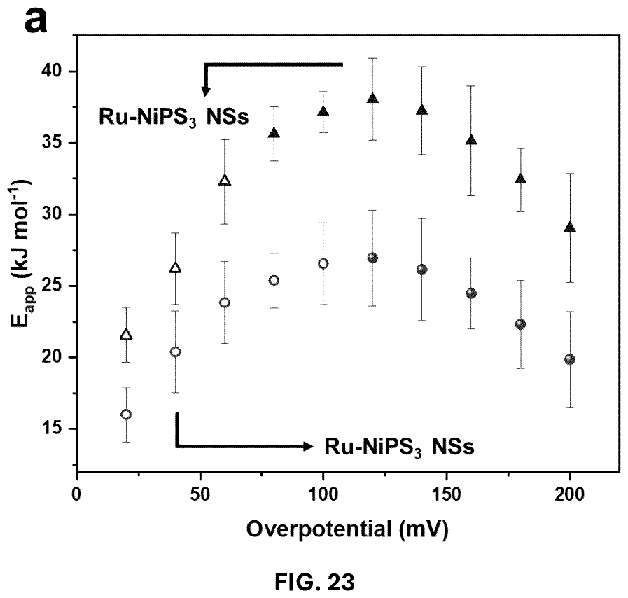

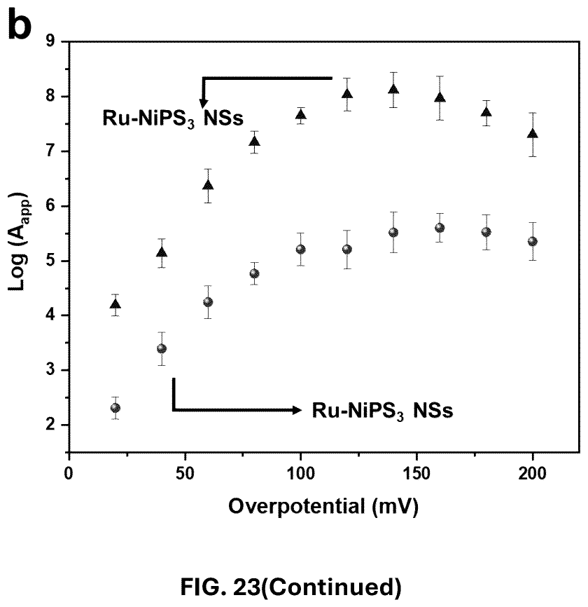

FIGS. 21a-21b show LSV curves of (a) NiPS₃ and (b) Ru—NiPS₃ obtained under different temperatures in 1 M KOH solution. These results were used to calculate the apparent activation energy (Eₐₚₚ) and the pre-exponential factor (Aₐₚₚ) for both catalysts. Eₐₚₚ and Aₐₚₚ were then calculated according to the Arrhenius equation by fitting the Arrhenius curve (FIGS. 23a-23b). It was found that the maximum value of Eₐₚₚ for NiPS₃ NSs appeared around its onset potential, while the maximum value for Ru—NiPS₃ was at a relatively high overpotential.

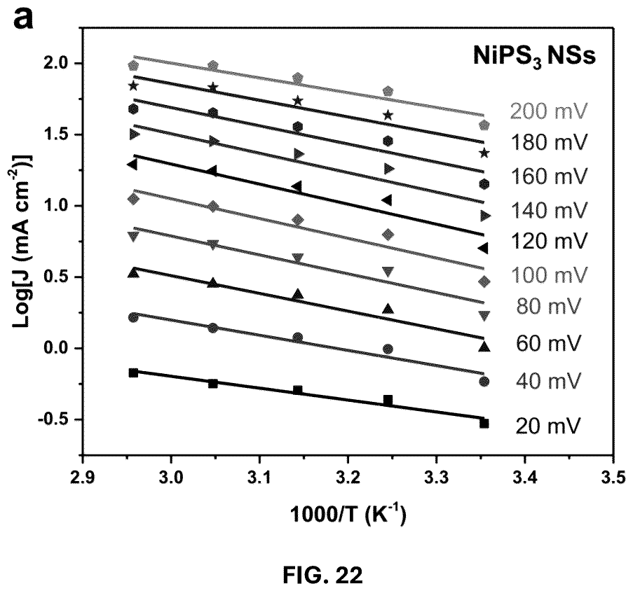

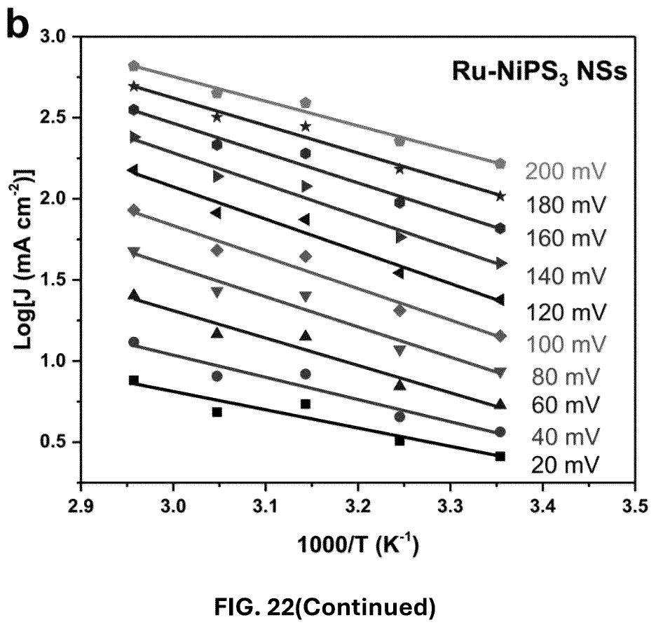

FIGS. 22a-22b show the logarithm of the catalytic current density plotted against 1000 times the reciprocal of the temperature (in Kelvin) to extract the apparent activation energy (Eapp) and the pre-exponential factor (Aapp) of the HER on (a) NiPS₃ and (b) Ru—NiPS₃ at fixed overpotentials using Arrhenius plots.

FIGs. 23a-23b show (a) Eₐₚₚ and (b) The logarithm of pre-exponential factor Aₐₚₚ derived from the intercept during the extraction of Eₐₚₚ for NiPS₃ and Ru—NiPS₃ at fixed overpotentials using the Arrhenius plots, as shown in FIG. 20.

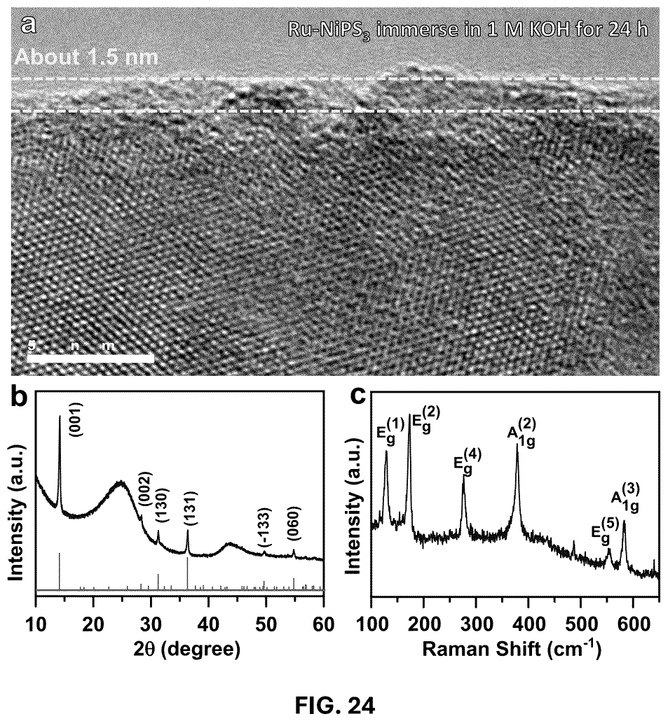

FIG. 24 shows (a) HRTEM image, (b) XRD pattern, and (c) Raman spectrum of Ru—NiPS₃ NSs after immersing in 1 M KOH solution for 24 h. In FIG. 24 (a), an amorphous layer having a thickness of about 1.5 nm formed on the edge of Ru—NiPS₃ NSs. According to FIG. 24 (b)-(c), the nanosheets still demonstrate the typical characteristic peaks of Ru—NiPS₃, which proved that the contact of alkaline media with the nanosheets is not the main cause for the amorphization.

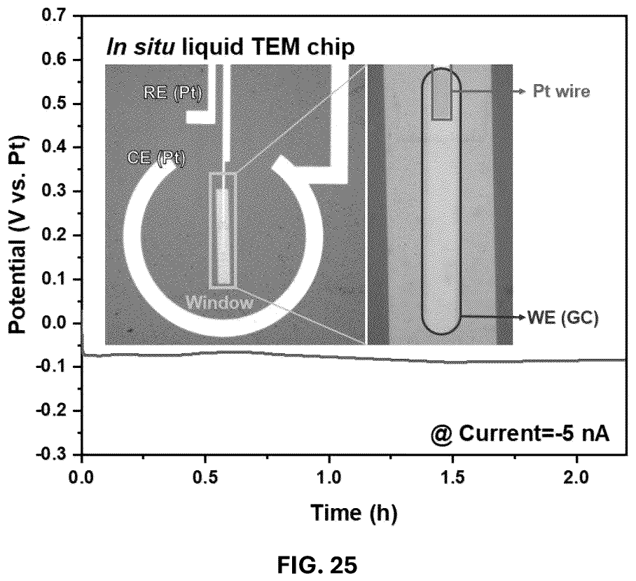

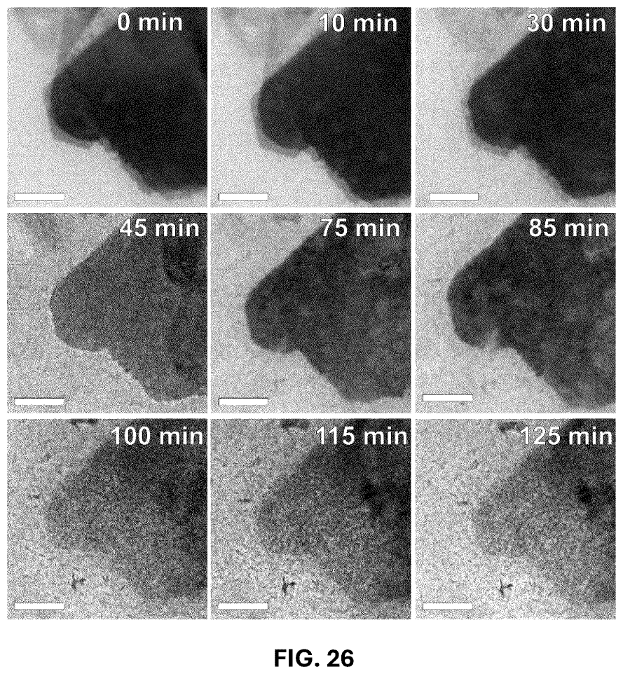

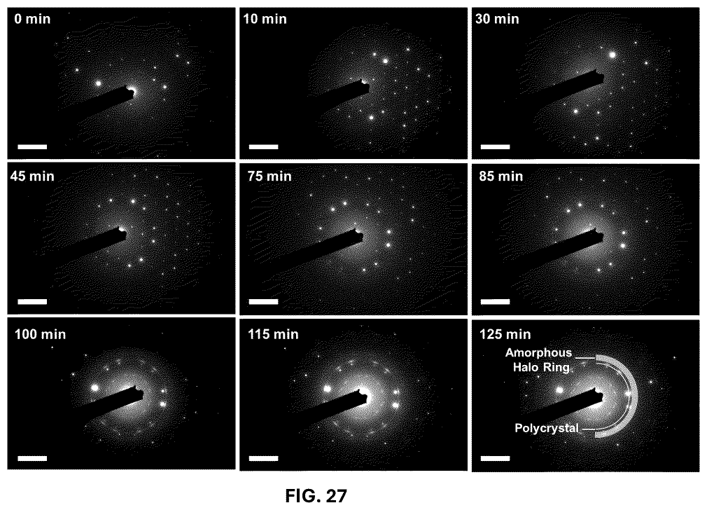

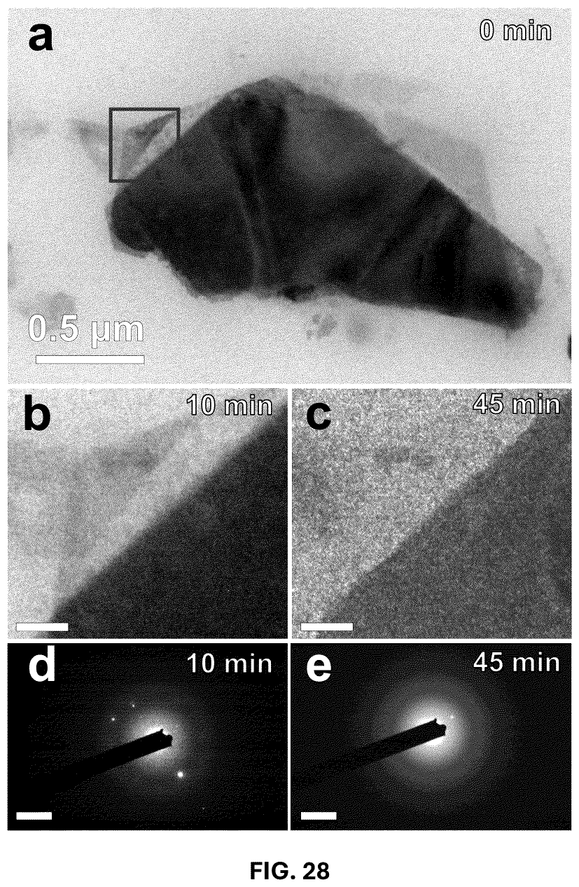

To observe the in situ morphological evolution of Ru—NiPS₃ NSs in Preparation Example 6, a JEM-2100F electron microscope operated at 200 kV was used in conjunction with a liquid TEM holder (Protochips, Poseidon Select) (FIG. 25). The electron flux was calculated to be about 20 e·Å⁻² s⁻¹. The liquid electrochemical chips (Protochips E-chips, ECT-45CR) are composed of two silicon chips, which are washed in acetone, methanol, and ethanol for 5 min, respectively, to remove the protective coating. Ru—NiPS₃ ink was then dropped onto the silicon nitride (SiNₓ) window, and the chips were further cleaned with Ar/O₂ plasma for 30 s. The in situ observation was conducted in an alkaline media solution (0.1M NaOH), and a Gamry 600+ potentiostat (Gamry, Warminster, PA) was used to provide a constant current of −5 nA vs. Pt during the whole observation. The electrolyte flow rate is controlled at 200 μL h⁻¹ to avoid damaging the SiNₓ window. In order to obtain clear TEM images with good spatial resolution, the samples in these in situ liquid TEM experiments were imaged within a thin liquid layer. It should be noted that the applied experimental conditions in these studies may not perfectly replicate those of a realistic electrochemical cell. As a result, there may be minor differences between the results obtained from in situ and ex situ measurements. FIGS. 26-28 demonstrate the formation of the amorphous layer.

The inventor further investigated the HER performances of different catalyst. All electrochemical measurements were conducted using a typical three-electrode cell with a CHI 760E electrochemical workstation (CH Instruments, Inc. Shanghai). The as-systemized electrode, Hg/HgO electrode, and graphite rod (Alfa Aesar, 99.9995%) were used as the working electrode, reference electrode, and counter electrode, respectively. Before the LSV test in 1M KOH electrolyte, all electrodes were activated by the cyclic voltammetry (CV) technique for 100 cycles to obtain stable LSV curves. The scan rate is 50 m V s⁻¹, within the potential range from −0.8 V vs. Hg/HgO to −1.5 V vs. Hg/HgO, and the total activation time is about 1 h. To avoid the influence of the Ru species dissolved in the electrolyte during the activation process, the electrode was replaced immediately when the activation process is finished. LSV curves were then obtained with a scan rate of 2 mV s⁻¹. In this work, all potentials were converted to RHE with the equation E_{RHE}=E_{Hg/HgO}+0.098 V+0.059×pH. EIS measurements were carried out within a frequency range of 106 Hz to 10-2 Hz, and the charge transfer resistance (Ra) obtained by fitting the EIS data was used for the iR correction. The results of HER performance of each sample are summarized in Table 3.

TABLE 3
HER performances of each sample

| | | Tafel Slope | | | |
|---|---|---|---|---|---|
| Sample | η₁₀ (mV) | (mV dec⁻¹) | j₀ (μA cm⁻²) | Rₛ (Ω) | R_{ct} (Ω) |
| NiPS₃ | 266 | 115.1 | 48 | 3.1 | 23.1 |
| powder | | | | | |
| NiPS₃ NSs | 146 | 77.8 | 130 | 3.5 | 11.8 |
| Ru—NiPS₃ | 58 | 64.0 | 1180 | 2.8 | 2.1 |
| NSs | | | | | |
| (Example 6) | | | | | |

As can be seen, h₁₀ and Tafel Slope for Ru—NiPS₃ NSs are significantly lower than other samples, and surprisingly the j₀ for Ru—NiPS₃ NSs is almost 10 times of that for NiPS₃ NSs, and almost 25 times of that for NiPS₃ powder.

### 2. Stability of the Catalyst in HER

Stability tests were conducted in 1 M KOH solution with Hg/HgO serve as the reference electrode and graphite rod to serve as the counter electrode. During the stability test, the sample was tested under the current density of 10 mA cm-2.

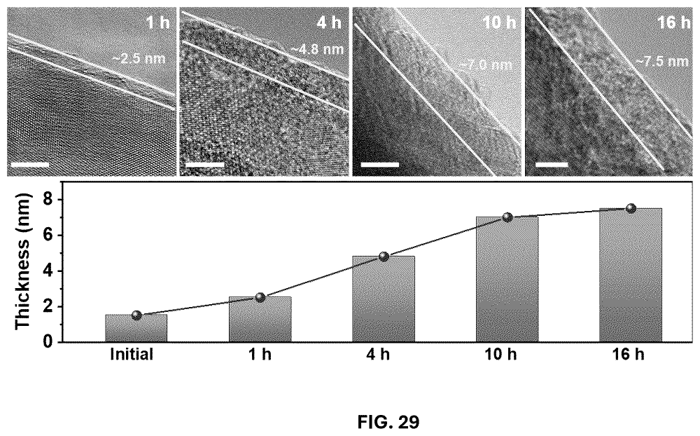

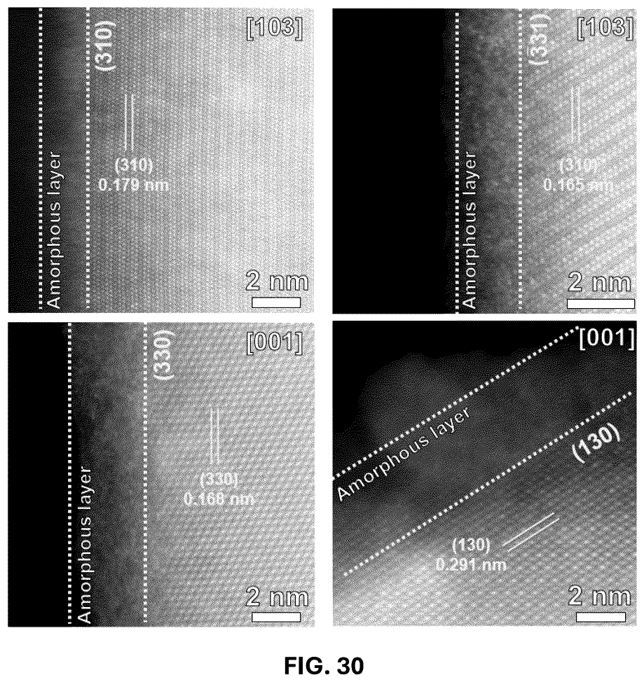

The results in FIG. 29 demonstrate that as the reaction progresses (0-16 hours), the thickness of the amorphous layer around the nano flakes tends to stabilize (˜8 nm) after 10 hours, thereby stabilizing the overall structure of the catalyst. The HDDF-STEM images of Ru—NiPS₃ along [001] and [103] zone axis show the amorphization process is independent of the crystal plane orientation (FIG. 30).

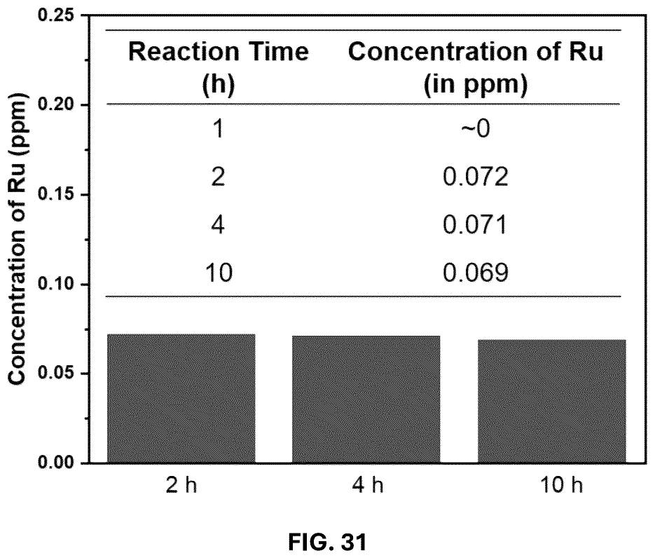

Taking the catalyst sample in Preparation Example 6 as a research object, the inventors further investigated the change the concentration of Ru with the reaction time of HER. It can be observed from FIG. 31 that the maximum concentration of 0.072 ppm was reached at the reaction time of 2 hours, and then the concentration slightly decreased to 0.071 over 4 hours, followed by 0.069 ppm over 10 hours. The concentration of Ru in the catalyst sample was substantially stable as the HER reaction progressed.

Table 4 shows the catalytic performances of Ru—NiPS₃ NSs in Example 6 in 1 M KOH. The produced Ru—NiPS₃ can achieve an overpotential of 58 mV and a Tafel slope of 64.0 of mV dec⁻¹, which are significantly lower than other reported Ni-based electrocatalysts.

TABLE 4
The catalytic performances of Ru—NiPS₃ in 1M KOH solution

| | Overpotential | Tafel Slope |
|---|---|---|
| Sample | (mV@10 mA cm⁻²) | (mV dec⁻¹) |
| Ru—NiPS₃ | 58 | 64.0 |

What is claimed is:

1. A method for preparing a doped metal phosphorus trichalcogenide (dMPT), the method comprising:
(a) contacting a first metal salt, an optional base and a fluorine salt under hydrothermal conditions thereby growing a first metal precursor on a conductive substrate;
(b) contacting the first metal precursor with an aqueous solution comprising a second metal salt thereby forming a doped metal precursor; and
(c) contacting the doped metal precursor, phosphorus, and sulfur thereby forming a mixture; and
heating the mixture thereby forming the doped metal phosphorus trichalcogenide;
wherein the first metal salt is a salt of nickel, manganese, iron or cobalt; and the second metal salt is a salt of ruthenium or platinum.

2. The method according to claim 1, wherein the conductive substrate is selected from carbon cloth, fluorine-doped tin oxide glass, nickel foam, and cobalt foam.

3. The method according to claim 1, wherein the first metal salt is selected from the group consisting of nitrate, phosphate, sulfate, chloride, bromide, iodide, and acetate, or hydrates thereof.

4. The method according to claim 1, wherein the phosphorus comprises red phosphorus.

5. The method according to claim 1, wherein the hydrothermal conditions in step (a) comprise at least one of a temperature of 100-150° C. and a reaction time of 5-12 hours.

6. The method according to claim 1, wherein the molar ratio of the first metal salt, the base and fluoride salt in step (a) is 1:2-8-6:2-5.

7. The method according to claim 1, wherein in step (b), the first metal precursor is contacted with the aqueous solution comprising the second metal salt for 0.5-20 hours.

8. The method according to claim 1, wherein the second metal salt has a concentration of 1-10 mg/ml in the aqueous solution.

9. The method according to claim 1, wherein in step (c) the doped metal precursor, phosphorus and sulfur are heated at 280-330° C. for at least 20 minutes followed by 420-480° C. for 4-8 hours.

10. The method according to claim 9, wherein the doped metal precursor, phosphorus and sulfur are heated at a heating rate of 1-10° C./min.

11. The method according to claim 1, wherein in step (c), the molar ratio of the first metal in the doped metal precursor, phosphorus and sulfur is 1:0.5-2:2-4.

12. The method according to claim 1, wherein the second metal is present in an amount from 0.1 to 2 wt % based on the weight of the dMPT.

13. A doped metal phosphorus trichalcogenide (dMPT) obtained by the method of claim 1.

14. The dMPT according to claim 13, wherein the dMPT comprises a plurality of hexagonal nanosheets.

15. The dMPT according to claim 13, wherein the dMPT further comprises an amorphous layer on at least one surface of the dMPT.

16. The dMPT according to claim 13, wherein the first metal is present in an amount from 0.1 to 2 wt % based on the weight of the dMPT.

17. The dMPT according to claim 13, wherein the second metal is present in an amount from 0.1 to 2 wt % based on the weight of the dMPT.

18. An electrode comprising the dMPT according to claim 13 and a base electrode, wherein the base electrode is a planar electrode, including the glassy carbon electrode, a graphite electrode, an indium tin oxide (ITO) electrode, a fluorine doped tin oxide (FTO) electrode, a gas diffusion electrode (GDE), carbon paper electrode, carbon fiber electrode, polycarbonate track etch (PCTE)-based electrode, or titanium-based electrode.

19. An electrochemical cell comprising the electrode of claim 18, a counter electrode, optionally a reference electrode, and an electrolyte solution comprising water and optionally hydroxide ion.

20. A method of producing hydrogen gas, the method comprising providing the of the electrochemical cell of claim 19; and applying an electric current between the electrode and the counter electrode resulting in the electrolytic reduction of water and the formation of hydrogen gas.
